(19) United States
(12) Patent Application Publication
(10) Pub. No.: US 2013/0091007 A1
(43) Pub. Date: Apr. 11, 2013

(54) Method and Apparatus for Automated Impact Analysis

(71) Applicants: Choongsoon Bae, Mountain View, CA (US); Adam Ghobarah, Santa Clara, CA (US); James Koehler, Boulder, CO (US)

(72) Inventors: Choongsoon Bae, Mountain View, CA (US); Adam Ghobarah, Santa Clara, CA (US); James Koehler, Boulder, CO (US)

(21) Appl. No.: 13/253,514

(22) Filed: Oct. 5, 2011

(51) Int. Cl. G06Q 30/02

(52) U.S. Cl. 705/14.41

(57) ABSTRACT

A method and system for automatically analyzing the impact of a treatment of interest is disclosed. Data related to a treatment of interest and a population including a treated group and a non-treated group is received. Propensity scores are estimated for the treated group and the non-treated group. Subgroups of the treated group and the non-treated group are matched based on the propensity scores. An outcome model is generated for each subgroup of the non-treated group, and an impact of the treatment on the treated group is generated for each subgroup of the treated group using the outcome model generated for the matching subgroup of the control group. Outcome models may be generated for the treated group and the non-treated group, and an impact of the treatment on the population may be generated based on the propensity scores and the outcome models for the test group and the non-treated group.

### BACKGROUND OF THE INVENTION

The present invention relates to analyzing the impact of a particular feature or service, and more particularly, to automatically automated impact analysis of services and features on on-line advertisers.

An on-line advertising system may provide advertisements to users when they visit certain web pages. When a particular advertisement is of interest to a user, the user may perform various actions, such as selecting or clicking on the advertisement, which may take the user to a web page belonging to the advertiser associated with the advertisement. Additional examples of user actions may include signing-up for services at the target web page, placing an order, etc. On-line advertising systems may charge advertisers based, at least in part, on a number of clicks an advertisement receives.

On-line advertising systems continually develop and implemented new features and services for advertisers. It is important to identify whether such new features and services have a positive impact and to estimate the impact of a particular feature or service. However, properly attributing cause-effect relationships related to a particular feature or service is typically difficult in the presence of confounding factors that can lead to false attribution of cause and effect. For example, many issues, such as selection bias of the advertisers who have received the benefit of the feature or service, seasonality, and economic cycle make it difficult to accurately analyze the actual impact of the particular feature or service. In many cases, traditional randomized controlled experiment designs are not realistic for analyzing the impact of a particular good or service.

### BRIEF SUMMARY OF THE INVENTION

The present invention provides a method and system for automated impact analysis of a treatment applied to a portion of a population. Embodiments of the present invention provide an automated method to measure the impact of a treatment (e.g., feature or service) independent of other factors, such as selection bias, seasonality, and economic cycle.

In one embodiment of the present invention, data related to a treatment of interest and a population including a treated group and a non-treated group is received. Propensity scores are estimated for the treated group and the non-treated group based on the data. Subgroups of the treated group and the non-treated group are matched based on the propensity scores. An outcome model is generated for each subgroup of the non-treated group, and an impact of the treatment on the treated group is generated estimated outcomes for each subgroup of the treated group using the outcome model generated for the matching subgroup of the control group.

Outcome models may also be generated for the treated group and the non-treated group, and an impact of the treatment on the population may be generated based on the propensity scores and the outcome models for the test group and the non-treated group

These and other advantages of the invention will be apparent to those of ordinary skill in the art by reference to the following detailed description and the accompanying drawings.

### BRIEF DESCRIPTION OF THE DRAWINGS

FIG. 1 illustrates an impact analysis system according to an embodiment of the present invention;

FIG. 2 is a block diagram illustrating a population being split into treated and non-treated groups according to Scenario 1;

FIG. 3 is a block diagram illustrating a population being split into treated and non-treated groups according to Scenario 2;

FIG. 4 is a block diagram illustrating a population being split into treated and non-treated groups according to scenario 3;

FIG. 5 illustrates a method of automated impact analysis of a treatment of interest according to an embodiment of the present invention;

FIG. 6 illustrates a method for detecting the scenario according to an embodiment of the present invention;

FIG. 7 illustrates a method for calculating the impact of a treatment on the treated group according to an embodiment of the present invention;

FIG. 8 illustrates a SRF algorithm according to an embodiment of the present invention;

FIG. 9 illustrates a method of calculating impact of a treatment in the population according to an embodiment of the present invention; and

FIG. 10 is a high level block diagram of a computer capable of implementing the present invention.

### DETAILED DESCRIPTION

The present invention is directed to a method and system for automatically analyzing the impact of a treatment of interest. As used herein a “treatment” is any service, feature, product, or program applied to a portion of a population. As described herein, embodiments of the present invention relate to automatically analyzing the impact of a treatment of interest on on-line advertisers. For example, embodiments of the present invention may be used to analyze the impact of services or features applied to certain on-line advertisers, such as particular sales activities directed to certain on-line advertisers, features offered to on-line advertisers to increase the effectiveness of their advertising, and marketing events offered to certain on-line advertisers. However, the present invention is not limited to treatment of on-line advertisers, and may be similarly applied to analyze the impact of various services, features, products, programs, etc., in various other industries and fields as well. For example, embodiments of the present invention can be applied to analyze the impact of certain medicines in clinical trials, and to analyze the impact of promotions in retail stores.

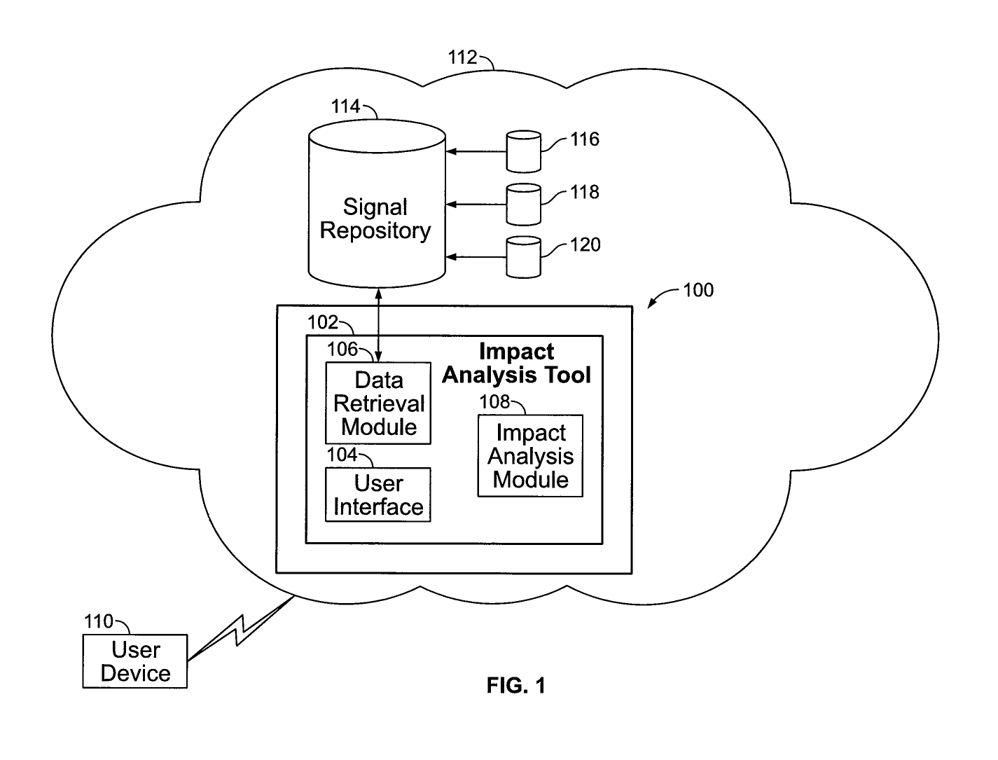

FIG. 1 illustrates an impact analysis system according to an embodiment of the present invention. As illustrated in FIG. 1, an impact analysis server 100 maintains an impact analysis tool 102. The impact analysis tool 102 can be implemented by a processor (not shown) of the impact analysis server 100 executing stored instructions. The impact analysis tool 102 is a tool that analyzes the impact of a treatment, such as service, feature, product, or program that is applied to a portion of a population. For example, the impact analysis tool 102 of FIG. 1 can analyze the impact of a treatment of interest on on-line advertisers. The impact analysis tool 102 includes a user interface 104, a signal retrieval module 106, and an impact analysis module 108.

The user interface 104 provides an interface for a user to access and control the impact analysis tool 102 from a remote user device 110. The user device can connect to the server via a network 112, such as the Internet or a mobile network, using well known network protocols. In a possible implementation, the user interface 104 can be accessed through a web browser of the user device 110 in order to provide a web-based user interface for remote users. Through the user interface 104, the impact analysis tool 102 can receive information relating to a treatment of interest that is entered by a user. For example, a user can input customer information, such as customer IDs (CIDs) relating to customers in the treated group and the non-treated group, treatment information, such as the treatment dates, and other profile variables, such as parameters that indicate which metrics (e.g., clicks, money spent, etc.) to use to analyze the impact of the treatment. The user interface 104 may provide various menus, options, prompts, etc., in order to allow the user to easily input the necessary information.

The signal retrieval module 106 of the impact analysis tool 102 retrieves data necessary to perform the impact analysis from a signal repository 114. The signal repository stores feature variables that are used as input signals to build propensity models and outcome models. The feature variables (i.e., input signals) can include both continuous and categorical variables. The signal repository 114 also stores outcome data. The signal repository 114 retrieves this data from various data sources 116, 118, and 120 and stores the data for a certain time frame. The data sources can include a customer database 116, an advertiser database 118, and an activity database 120. The customer database 116 stores records of outcome data, such as clicks, money spent, etc., for various customers. The advertiser database 118 stores CIDs for various customers, as well as other information relating to the customers, such as size, financial information, business type, etc, which can be used as input features. The activity database 120 may store activity/treatment information. For example, the activity database 120 may store information that indicates whether a certain CID received certain services/treatments and when. Although it is possible for the impact analysis tool 102 to query the data sources 116, 118, and 120 in real time to collect the necessary data, this query will run in real time on large amounts of data, and may be inefficient.

According to an advantageous implementation, the signal repository 114 stores the signals for all CIDs for a certain time period, such as a week. For example, the signal repository 114 can store these signals in a distributed structured storage system, such as bigtable. This allows the signal repository 114 to be quickly queried by the signal retrieval module 106 in order to retrieve the signal data and outcome variables necessary to perform a requested impact analysis. The signal repository 114 can be keyed by CID, and only one locality group is needed since the signals can be all pulled by the signal retrieval module 106 together. Timestamps or dates can be the third dimension in the table. The two column families in the signal repository 114 can be: (1) features and (2) outcomes. The features columns correspond to various feature variables and can store feature data in a raw format, such as strings. The outcome columns correspond to outcome variables. The signal repository 114 can be updated at a regular time interval, such as every week. For example, the signal repository 114 can be updated using various types of known scripts or protocols to retrieve the signal and outcomes from the data sources 116, 118, and 120.

Once the feature variables (signals) and outcomes corresponding to a certain treatment of interest are retrieved by the signal retrieval module 106, the impact analysis module 108 uses the feature variables and outcomes to analyze the treatment of interest. According to various embodiments of the present invention, the feature analysis module 108 can estimate the effect of the treatment of interest on the treated group and the effect of the treatment of interest on the entire population. In particular, the signal retrieval module 106 utilizes the methods of FIGS. 5-9, described below to analyze the treatment of interest.

The impact analysis tool 102 then outputs the results of the treatment analysis to a user. For example, the impact analysis tool 102 can transmit the analysis results to the user device 110 over the network 112, where the results can be stored and/or viewed by the user. In a possible implementation, the results can be presented to the user in the user interface 104.

In order to understand the automated impact analysis of a treatment of interest on a portion of a population, a general framework of the automated impact analysis problem is first discussed. Suppose there is a random sample size n from a large population. For each unit i (e.g., advertiser i) in the sample, let Zᵢ indicate whether the treatment of interest was received. That is, Zᵢ=1 if the unit i received the treatment and Zᵢ=0 of the unit i did not receive the treatment. Two ways to measure the impact of the treatment is to measure the average impact of the treatment on the population,

δₚₒₚ= [symbol] [Yᵢ¹]− [symbol] [Yᵢ⁰], (1)

or the average impact on the treated group,

δₜᵣ= [symbol] [Yᵢ¹|Zᵢ=1]− [symbol] [Yᵢ⁰|Zᵢ=1], 2)

where Yᵢ¹ is the outcome for unit i when unit i received the treatment and Yᵢ⁰ is the outcome for unit i when unit i did not receive the treatment.

The difficulty in estimating δₚₒₚ or δₜᵣ is that only Yᵢ¹ or Yᵢ⁰ can be observed for a particular unit, but not both. In order to estimate effects of treatment or non-treatment on particular units, feature variables (input signals) Xᵢ that include both continuous and categorical variables are used. For example, for a particular advertiser i, Xᵢ can include static characteristics of the advertiser, such as vertical and country, and summaries of activities, such as weekly spend. Vertical refers to the category of an advertiser, i.e. whether they are advertising travel related items, or educational items, etc. The only restriction on Xᵢ is that the variables should depend only on information that could be collected before the treatment started. For simplicity, let Yᵢ=Zᵢ×Yᵢ¹+(1−Zᵢ)×Yᵢ⁰. Then, the problem is to determine the estimation \hat{δ}ₚₒₚ or \hat{δ}ₜᵣ using observed data (Yᵢ,Zᵢ,Xᵢ) for all iε1, K, n. For convenience, let (Y, Z, X) be random variables and (Yᵢ,Zᵢ, Xᵢ), i=1, K, n be considered as observed values of (Y, Z, X).

Embodiments of the present invention consider four possible scenarios for splitting a treated group and a control group for measuring the impact of a treatment of interest. Scenario 0 refers to randomized controlled experiment designs, which are traditionally the easiest way to measure the impact. In Scenario 0, it is sufficient to directly compare the outcome of test and control groups. However, in many cases, this scenario is not realistic.

In Scenario 1, test and control groups are randomly split before offering treatment. However, a unit i that is in the random test group may not get the treatment because unit i did not want to get the treatment or for other reasons which cannot be controlled. For example, a test and a control group can be randomly split among all advertisers, and all advertisers in the test group can be contacted to offer a service to the advertisers in the test group. However, some of contacted advertisers may not accept the service offer. In this case, Zᵢ=1 if unit i accepts the service offer. One of advantages in scenario 1 is that P[Z=1][X=x], the probability of accepting the service offer if contacted, can be estimated using test (contacted) group. A classifier can be applied to select units in the control (not contacted) group who are likely to accept service offers (i.e., units whose P[Z=1][X=x] is large).

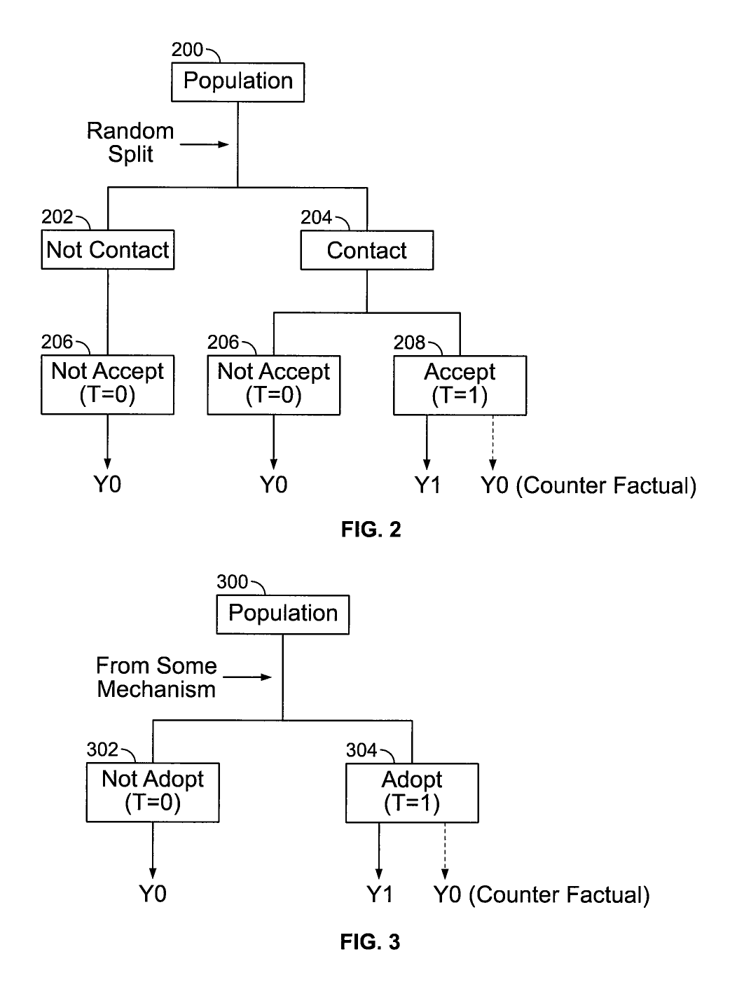

FIG. 2 is a block diagram illustrating a population being split into treated and non-treated groups according to Scenario 1. As illustrated in FIG. 2, a population 200 is randomly split into a not contact group 202 (control group) and a contact group 204 (test group). All units (e.g., advertisers) of the contact group 204 are contacted and offered a treatment, while the not contact group 202 is not contacted. Since the not contact group 202 are not offered the treatment, all units in the not contact group do not accept the treatment and are part of the non-treated group 206 (T=0). Some of the units in the contact group 202 also do not accept the treatment and are part of the non-treated group 206 (T=0). An outcome Y0 is observed for each unit of the non-treated group 206. Some of the units in the contact group 202 accept the treatment, and these units are the treated group 208 (T=1). An outcome Y1 is observed for each unit of the treated group 208. Further, in order to estimate the impact of the treatment on the treated group 208, a counterfactual outcome of Y0 can be estimated for each unit of the treated group 208. That is, it is estimated what outcome would have occurred for each unit in the treated group 208 of that unit had not been treated. The impact on the treated group 208 can then be estimated as E(Y1|T=1)−E(Y0|T=1). Since in Scenario 1, the population 200 is randomly split, the impact on the population does not have to be calculated separately from the impact on the treated group.

Scenario 2 is more realistic than scenario 1 but more difficult to analyze. In many observational studies, the treated group and non-treated group are split according to scenario 2. In scenario 2, the test and control group cannot and should not be split randomly. For example, assume that the impact of a new treatment for a certain disease is to be measured. One cannot or should not necessarily choose patients who will get the treatment. Patients, themselves, should choose whether they will get the treatment or not based on factors, such as their economic conditions or beliefs. In this case, Zᵢ=1 if patient i gets the treatment. The issue to be considered is that there may be some difference between test (treated) group and control (not treated) group. That is, there may be some mechanism that leads certain units to adopt treatment and other units not to adopt treatment. Accordingly, it is not proper to simply compare the two groups directly to measure the impact of a new treatment.

FIG. 3 is a block diagram illustrating a population being split into treated and non-treated groups according to Scenario 2. As illustrated in FIG. 3, a population 300 is split from some mechanism into units who do not adopt a treatment (non-treated group T=0) 302 and units who do adopt the treatment (treated group T=1) 304. An outcome Y0 is observed for each unit of the non-treated group 302. The mechanism that units of the population 300 use to determine whether to adopt or not adopt the treatment may be unknown. An outcome Y1 is observed for each unit of the treated group 304. Further, in order to estimate the impact of the treatment on the treated group 208, a counterfactual outcome of Y0 can be estimated for each unit of the treated group 208. That is, it is estimated what outcome would have occurred for each unit in the treated group 208 if that unit had not been treated. The impact on the treated group 304 can be estimated as E(Y1|T=1)−E(Y0|T=1) and the impact on the population 300 can be estimated as E(Y1)−E(Y0).

Scenario 3 is a hybrid of scenario 1 and scenario 2. Similar to scenario 1, there are test and control groups in scenario 3. However, these groups are not determined from a random selection procedure. Accordingly, there may be unknown reasons why some units are in the test group and some are not. Further, within the test group, some units accept service offers and some units do not. In this case, Zᵢ=1 if unit i accepts the treatment. Many whitelist trials are included in this scenario. For example, a customer service representative (CSR) can choose a set of advertisers who are first offered a new feature in the ads front-end. Some advertisers may be chosen because they have asked for the new feature, some may be chosen because the CSR believes that the new feature will benefit the advertiser, some may be chose because the advertiser is not entirely satisfied, and some may be chosen for other reasons that may not be clear. Some of the advertisers offered the new feature by the CSR chose to use the new feature and some chose not to use the new feature. Scenario 3 is similar to scenario 1 except for the random sampling of test and control groups.

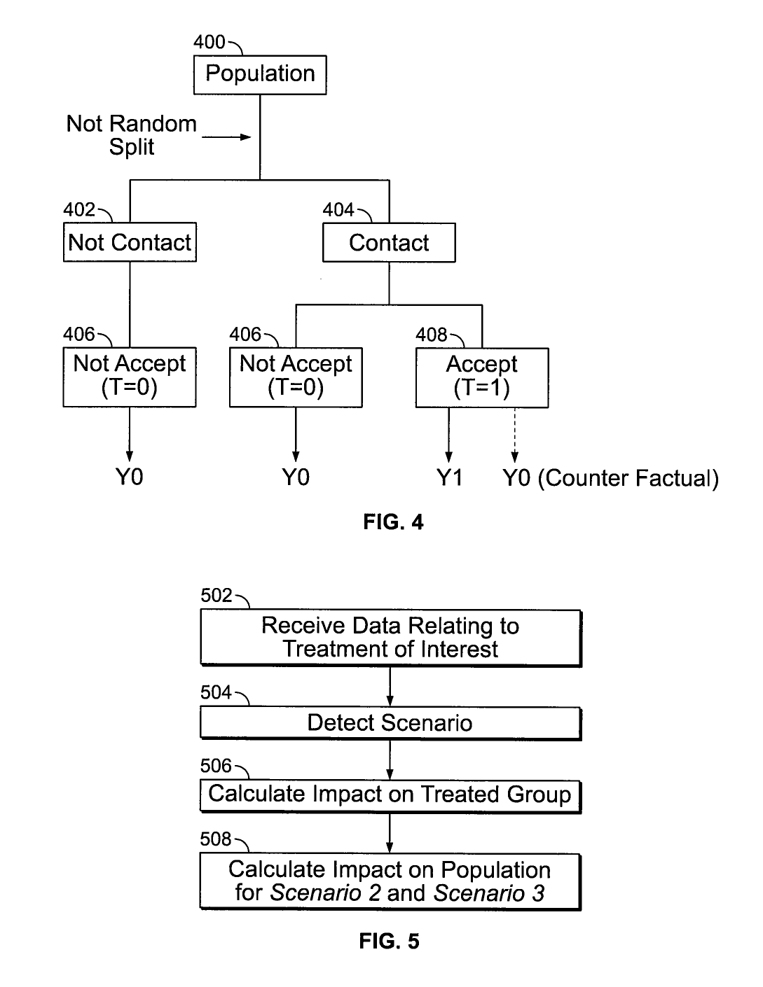

FIG. 4 is a block diagram illustrating a population being split into treated and non-treated groups according to scenario 3. As illustrated in FIG. 4, a population 400 is split into a not contact group 402 (control group) and a contact group 404 (test group). This split is not random and the units of the population 400 may be selected to be in the not contact group 402 or the contact group 404 for various reasons. All units (e.g., advertisers) of the contact group 404 are contacted and offered a treatment, while the not contact group 402 is not offered the treatment. Since the not contact group 402 are not contacted, all units in the not contact group do not accept the treatment and are part of the non-treated group 406 (T=0). Some of the units in the contact group 402 also do not accept the treatment and are part of the non-treated group 406 (T=0). An outcome Y0 is observed for each unit of the non-treated group 406. Some of the units in the contact group 402 accept the treatment, and these units are the treated group 408 (T=1). An outcome Y1 is observed for each unit of the treated group 408. Further, in order to estimate the impact of the treatment on the treated group 408, a counterfactual outcome of Y0 can be estimated for each unit of the treated group 408. That is, it is estimated what outcome would have occurred for each unit in the treated group 408 of that unit had not been treated. The impact on the treated group 408 can then be estimated as E(Y1|T=1)−E(Y0|T=1) and the impact on the population 300 can be estimated as E(Y1)−E(Y0).

As described above, the impact analysis tool 102 running on the impact analysis server 100 utilizes various statistical algorithms to measure the impact of a treatment of interest on a treated group and/or a population. In particular, embodiments of the present invention utilize various statistical algorithms in building propensity score models and outcome models to remove selection bias and the effect of seasonality, economic cycle, etc. In order to build these models, the impact analysis tool 102 can retrieve various feature variables from the signal repository 114 and uses the feature variables in the statistical algorithms. According to various embodiments of the present invention, different statistical algorithms can be used in various stages of the automated impact analysis based on the scenario associated with the treatment. An overview of various statistical algorithms that may be used in various embodiments of the present invention is provided below.

Propensity Score Models.

A propensity score p(x) can be defined as the conditional probability that an advertiser (unit) is in the status Z=1, where the advertiser has the characteristics x: p(x)=P[Z=1|X=x]. We can use p(x) as a rule to make the best pairs of treated and non-treated units. For example, when unit A is in the status 0 (non-treated) and unit B is in the status 1 (treated), if propensity scores p(x) for A and B are close, it can be assumed that the impacts of A and B are similar. The motivation for using propensity score methods is that the dimensionality of possible feature variables is high in many cases. When the dimension of feature variables is low, simple matching is straight forward. However, when the dimension is high, it is difficult to determine which feature variables should be used and which weighting scheme should be applied. The propensity score is useful under such circumstances because it provides variables and weights in a data driven way. Also the use of the propensity score is efficient in the sense that computational cost relatively inexpensive, especially when the dimension of feature variables is high and the number of sample is large.

Inverse Propensity Weighted (IPW) Estimation.

If input signal X contains enough information to remove selection bias (i.e., no unmeasurement cofounders assumption: (Y⁰,Y¹)⊥Z|X and 0<p(x)<1), then the observed outcomes can be expressed as:

[symbol]

[ [symbol] ZY¹|X)]= [symbol] [ [symbol] Y¹|X)p(X)] (3)

[symbol]

[ [symbol] ZY⁰|X)]= [symbol] [ [symbol] Y⁰|X)(1−p(X))] (4)

Combining (3) and (4) leads to the IPW estimation:

$${\hat{δ}}_{IPW} = \frac{1}{n} {\sum }_{i = 1}^{n} \{ \frac{{Z}_{i} {Y}_{i}}{\hat{p} ( {x}_{i} )} - \frac{( 1 - {Z}_{i} ) {Y}_{i}}{1 - \hat{p} ( {x}_{i} )} \} , \qquad ( 5 )$$

where \hat{p}(x) is an estimate of p(x). IPW is advantageous in that it is asymptotically unbiased when \hat{p}(x) is asymptotically unbiased. However, this means that it is required for the propensity model to be correct.

Doubly Robust Estimator.

Suppose that the true relationship is known between the outcome Y (outcome model) (e.g., the difference between pre-treatment advertiser spend and post treatment advertise spend) and the pre-treatment input signals X, that is represented as E[Y|X]=m(X,β) for unknown β, and that the treatment effect δₚₒₚ is the same for all advertisers. Then, it can be expressed:

[symbol]

[Y|X,Z]=m(X,β)+Zδₚₒₚ. (6)

It can be noted that:

$$\begin{matrix}E [ {Y}^{- 1} - {Y}^{0} ] = E [ E ( {Y}^{1} \vert X ) - E ( {Y}_{0} \vert X ) ] \\ = E [ E ( Y \vert Z = 1 , X ) - E ( Y \vert Z = 0 , X ) ] \\ = E [ m ( X , β ) + {δ}_{pop} - m ( X , β ) ] \\ = {δ}_{pop} .\end{matrix} \qquad \begin{matrix}\begin{matrix}\begin{matrix}( 7 ) \\ ( 8 )\end{matrix} \\ ( 9 )\end{matrix} \\ ( 10 )\end{matrix}$$

Thus, if δₚₒₚ is constant in X, an unbiased estimate of the regression coefficient, δₚₒₚ is an unbiased estimate of the average treatment effect. However, in practice, it is difficult to assume that δₚₒₚ is constant in X. IPW estimation shows comparative performance when the propensity score model is correct. However it is biased when the propensity score model is incorrect and its variance is large. Doubly Robust (DR) estimation is a combination of the two methods that is asymptotically unbiased even if either the outcome models or the propensity model is wrong. Let \hat{m}₁(x) and \hat{m}₀(x) be an estimation of E[Y¹|x] and E[Y⁰|x], respectively. Then, the DR estimator is defined as:

$${\hat{δ}}_{DR} = \frac{1}{n} {\sum }_{i = 1}^{n} ( {\hat{m}}_{1} ( {x}_{i} ) - {\hat{m}}_{0} ( {x}_{i} ) ) + \frac{1}{n} {\sum }_{i = 1}^{n} \frac{{Z}_{i} ( {Y}_{i} - {\hat{m}}_{1} ( {x}_{i} ) )}{\hat{p} ( {x}_{i} )} - \frac{1}{n} {\sum }_{i = 1}^{n} \frac{( 1 - {Z}_{i} ) ( {Y}_{i} - {\hat{m}}_{0} ( {x}_{i} ) )}{1 - \hat{p} ( {x}_{i} )} . \qquad ( 11 )$$

The DR estimator is acceptable to use when either the propensity model or the outcome model is correct. If the propensity model is correct, the DR estimator will have a smaller variance than IPW. If the outcome model id correct, the DR estimator may have a larger variance than just using the outcome model. However, the DR estimator provides protection in case the outcome model is not correct.

A simple estimate of the standard error of \hat{δ}_{DR} can be used to give confidence intervals of δ. Let

$$\begin{matrix} {\hat{δ}}_{DR} = \frac{1}{n} {\sum }_{i = 1}^{n} {δ}_{i} , \\ where & ( 12 ) \\ {δ}_{i} = {\hat{m}}_{1} ( {x}_{i} ) - {\hat{m}}_{0} ( {x}_{i} ) + \frac{{Z}_{i} ( {Y}_{i} - {\hat{m}}_{1} ( {x}_{i} ) )}{{\hat{p}}_{1} ( {x}_{i} )} - \frac{( 1 - {Z}_{i} ) ( {Y}_{i} - {\hat{m}}_{0} ( {x}_{i} ) )}{1 - {\hat{p}}_{1} ( {x}_{i} )} . & ( 13 )\end{matrix}$$

Then, the variance of \hat{δ}_{DR} can be estimated as:

$$Var ( {\hat{δ}}_{DR} ) = \frac{1}{{n}^{2}} {\sum }_{i = 1}^{n} {( {δ}_{i} - {\hat{δ}}_{DR} )}^{2} . \qquad ( 14 )$$

FIG. 5 illustrates a method of automated impact analysis of a treatment of interest according to an embodiment of the present invention. In one embodiment, the method of FIG. 5 can be performed by the impact analysis server 100, as illustrated in FIG. 1. Referring to FIG. 5, at 502, data relating to a treatment of interest is received. The data related to the treatment of interest can include identification of a treated group and a non-treated group. The treated group and the non-treated group can be identified by identifications of units (e.g., customer ids, advertiser ids) in the treated group and the non-treated group. The data can also include feature variables related to the units in the treated group and non-treated group. The feature variables for each unit can include static characteristics of the unit that depend on information that was collected before the treatment started, such as vertical and country, and summaries of activities, such as weekly spend. The data can also include outcome data, such as the observed outcomes for the units in the treated and non-treated groups. In one embodiment, the feature variables and outcome data related to the units in the treated and non-treated groups can be retrieved by the impact analysis tool 102 running on the impact analysis server 100 from the signal depository 114. Other data can include parameters that indicate which metrics (e.g., clicks, money spent, etc.) to use to analyze the impact of the treatment. For example, such parameters can be received as user input via a web interface.

At 504, a scenario relating to splitting the treated group and the non-treated group is detected. In particular, it is detected which of scenario 0, scenario 1, scenario 2, and scenario 3 applies to the treated and non-treated groups of the treatment of interest. The impact analysis tool 102 uses different statistical algorithms to measure the impact for the different scenarios. Accordingly, before the impact can be measures based on the data relating to a treatment of interest, it is determined which scenario applies to the data.

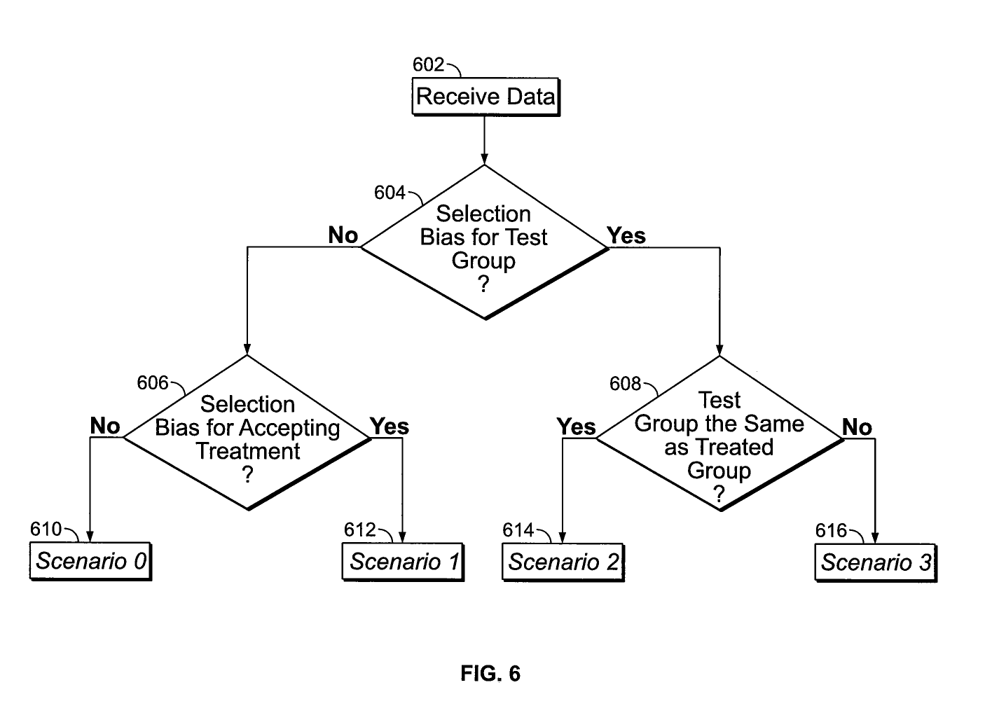

FIG. 6 illustrates a method for detecting the scenario according to an embodiment of the present invention. The method of FIG. 6 can be used for implementing step 504 of FIG. 5. As illustrated in FIG. 6, the data relating to the treatment of interest is received as step 602, which is the same as step 502 of FIG. 5. At step 604, it is determined whether there is a selection bias for the test (contacted) group. If the test (contacted) group and the control (non-contacted) group were randomly selected, then no selection bias exists and the method proceeds to step 606. If the test group and the control group were not randomly selected, there is a selection bias in the test group and the method proceeds to step 608.

At step 606, it is determined whether there is a selection bias for the members of the test (contacted) group that accepted treatment. If there is no selection bias for the treated group, that is the treated group and the non-treated group are randomly split, the method proceeds to step 610. If there is a selection bias for the treated group, that is those who accepted treatment in the test group (i.e., the treated group) is no randomly selected, the method proceeds to step 612. At step 610, it is determined that scenario 0 applies to the treated and non-treated groups in the data. In this case, it is only necessary to calculate the impact of the treatment on the treated group, and this can be accomplished by simply comparing the outcome between the test and control group, for example using Difference in Difference (DnD) methods. At step 612, it is determined that scenario 1 applies to the treated and non-treated groups in the data. In this case, it is only necessary to measure the impact of the treatment on the treated group (step 506 of FIG. 5), and not necessary to measure the impact of the treatment in the entire population (step 508 of FIG. 5).

At step 608, it is determined whether the test (contacted) group is the same as the treated group. If the test group is the same as the treated group, the method proceeds to step 614. If the test group is not the same as the treated group, that is some members of the test group do not accept treatment, the method proceeds to step 616. At step 614, it is determined that scenario 2 applies to the treated and non-treated groups in the data. At step 616, it is determined that scenario 3 applies to the treated and non-treated groups in the data. In the cases of both scenario 2 and scenario 3, the impact of the treatment on the treated group (step 506 of FIG. 5) is calculated and the impact of the treatment in the population (step 508 of FIG. 5) is calculated.

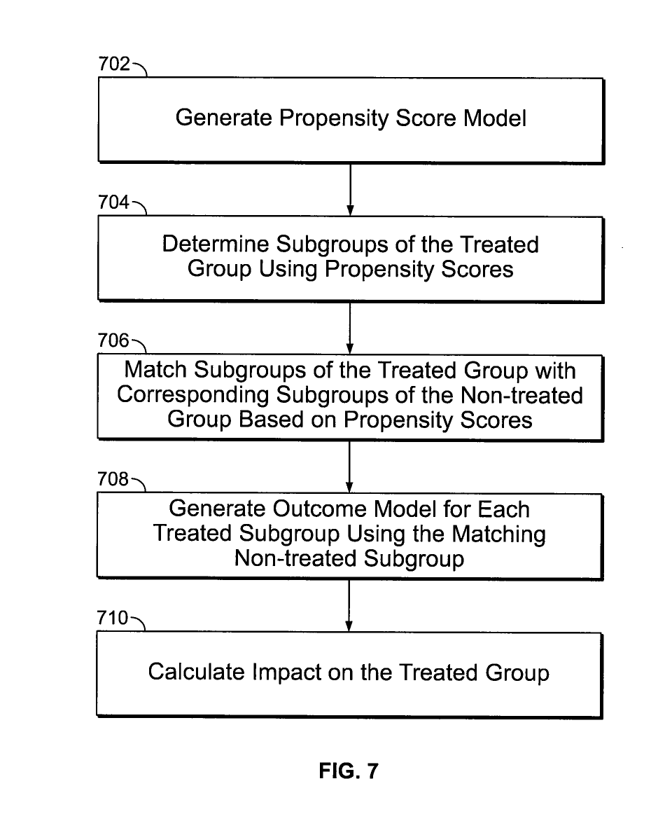

Returning to FIG. 5, at step 506, the impact of the treatment on the treated group is calculated. As described above, in the case of scenario 0, DnD methods can be used to compare the outcome between the treated and non-treated groups. However, in many cases scenario 0 is unrealistic. In scenario 1, scenario 2, and scenario 3, the impacted of the treated group is estimated using outcome models that estimate outcomes for members of the treated group if they had not received treatment. The outcome models are generated based on subgroups of the control group which are matched with subgroups of the treated group. The subgroups of the control group and treated group are determined using propensity scores, which are determined by building propensity score models. Different propensity score models are used based on the type of scenario determined for the data. FIG. 7 illustrates a method for calculating the impact of a treatment on the treated group according to an embodiment of the present invention. The method of FIG. 7 can be used to implement step 506 of FIG. 5.

Referring to FIG. 7, at step 702, a propensity score model is generated for the received data. The propensity score model is used to determine propensity scores for each data sample in the treated and non-treated groups. Different propensity score modeling techniques can be used for different scenarios. In scenario 1, because the contacted group is selected randomly, the propensity score model can be built using the contacted group only. Machine learning algorithms, such as Random Forests or Boosted trees, can be used to build the propensity score model based on the feature values in the received data. In an advantageous embodiment, a Random Forest algorithm is used to build the propensity score model because Random Forest algorithms are relatively resistant to irrelevant feature variables and show good performance as compared to other non-parametric machine learning methods. In scenario 2, it is possible that over-fitting can occur as a result of using non-parametric machine learning methods. Thus, in an advantageous implementation, Subsampled Random Forests (SRF) can be used can be used to estimate the propensity scores. In scenario 3, the contacted and not accepted group is first removed, the contacted and accepted group is used as the treated group, and the not contacted group is used as the non-treated group. SRF can then be used to estimate the propensity scores for the treated group and the non-treated group.

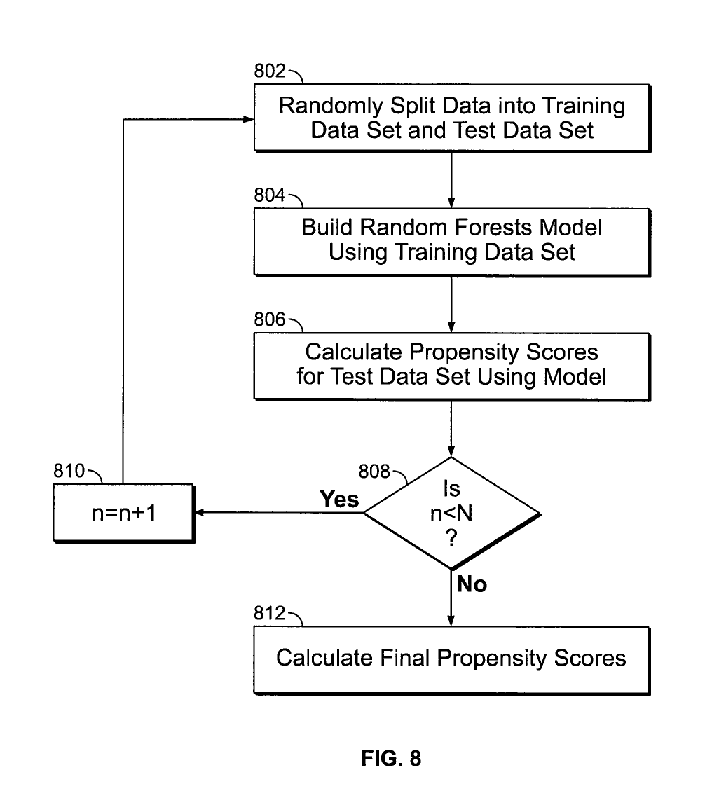

The SRF algorithm is a non-parametric Random Forests algorithm that is modified to be robust to overfitting. FIG. 8 illustrates a SRF algorithm according to an embodiment of the present invention. The method of FIG. 8 can be used to build the propensity model for the data in scenario 2 and scenario 3. As illustrated in FIG. 8, at step 102, the data is randomly split (e.g. 50:50) into a training data set and a test data set. At step 804, a Random Forests model is built using the training data set. At step 806, propensity scores are calculated for the testing data set using the model built in step 804. At step 808 it is determined whether an iteration number (n) is less than a target number (N) of iterations. If the iteration number (n) is less than the target number (N), the method proceeds to step 810. At step 810, the iteration number (n) is incremented (n=n+1), and the method repeats steps 802-808. If, at step 808, the iteration number (n) is no less that the target number (N), the method proceeds to step 812. At step 812, the final propensity scores at calculated as the average of the scores generated each iteration of step 806. According to an advantageous implementation, the target number (N) of iterations can be a relatively high number, such as 1000, but the present invention is not limited to a particular number of iterations.

Returning to FIG. 7, at step 704, subgroups of the treated group are determined using the propensity scores. The subgroups Sⱼ, j=1, K,J can be split based on quartiles of propensity score in the test group. According to various implementations, other restrictions can be applied on the determination of the subgroups. For example, in one embodiment, a maximum number of subgroups can be 10, and there must be at least 5,000 members of the control group that have propensity scores matching each subgroup. Such restrictions can also be used to determined a number J of subgroups Sⱼ.

At step 706, the subgroups of the treated group are matched with corresponding subgroups of the non-treated group based on propensity scores. That is, for each treated subgroup, a matching non-treated subgroup is defined having a matching range of propensity scores.

At step 708, an outcome model is generated for each treated subgroup using the matching non-treated subgroup. The outcome model mₒ(x) for a treated subgroup is a model that predicts the outcome for a member of the treated subgroup if the treatment had not been received based on the input feature values. That is mₒ(x)=E[Y⁰|X=x], where E[Y⁰|X=x] is the expected value for an outcome Y⁰ for a given feature vector X without receiving treatment. According to a possible embodiment, the outcome model mₒ(x), for a particular treated subgroup, can be generated using non-parametric estimations of E[Y⁰|X=x] using the matching non-treated subgroup as training data. For example, in an advantageous implementation, Random Forests, which are relatively resistant to irrelevant feature variables, can be used to generate the outcome model for each treated subgroup based on the corresponding matching non-treated subgroups. A separate outcome model is generated for each treated subgroup.

At step 710, the impact on the treated group is calculated using the outcome models. In particular, the outcome model for each treated subgroup can be used to estimate the outcomes for the members of that treated subgroup if treatment was not received based on the feature values for each member. The impact on the treated group can then be calculated as the difference between the mean of the outcomes of the treated group and the mean of the estimated outcomes for the treated group if treatment was not received (i.e., mean(Yₜᵣ¹)−mean(mₒ(Xₜᵣ)), where Yₜᵣ¹ denotes the outcomes for the treated group and Xₜᵣ denotes the feature values for the treated group). Accordingly, the impact \hat{δ}ₜᵣ on the treated group can be expressed as:

$${\hat{δ}}_{tr} = \frac{1}{{n}_{t}} {\sum }_{i = 1}^{{n}_{t}} {Y}_{i , tr} - \frac{1}{{n}_{t}} {\sum }_{i = 1}^{{n}_{t}} {\sum }_{j = 1}^{J} 1 ( {X}_{i , tr} ∈ {S}_{j} ) {\hat{m}}_{0}^{j} ( {X}_{i , tr} ) , \qquad ( 15 )$$

where Y_{i,tr} is the outcome of sample i in the treated group, X_{i,tr} is the feature vector for sample i in the treated group, nᵢ is the number of samples in the treated group, Sⱼ denotes the subgroups of the treated group, J is the number of subgroups, and \hat{m}₀^{j} is the outcome model for subgroup j of the treated group and is an estimation of m₀(x) generated using the matching subgroup of the non-treated group.

Returning to FIG. 5, at step 508, the impact of the treatment in the population is calculated for data in scenario 2 and scenario 3. As described above, it is not necessary to measure the impact of the treatment in the population for scenario 0 and scenario 1. Accordingly, for data in scenario 0 and scenario 1, the method ends after the impact on the treated group is calculated in step 506.

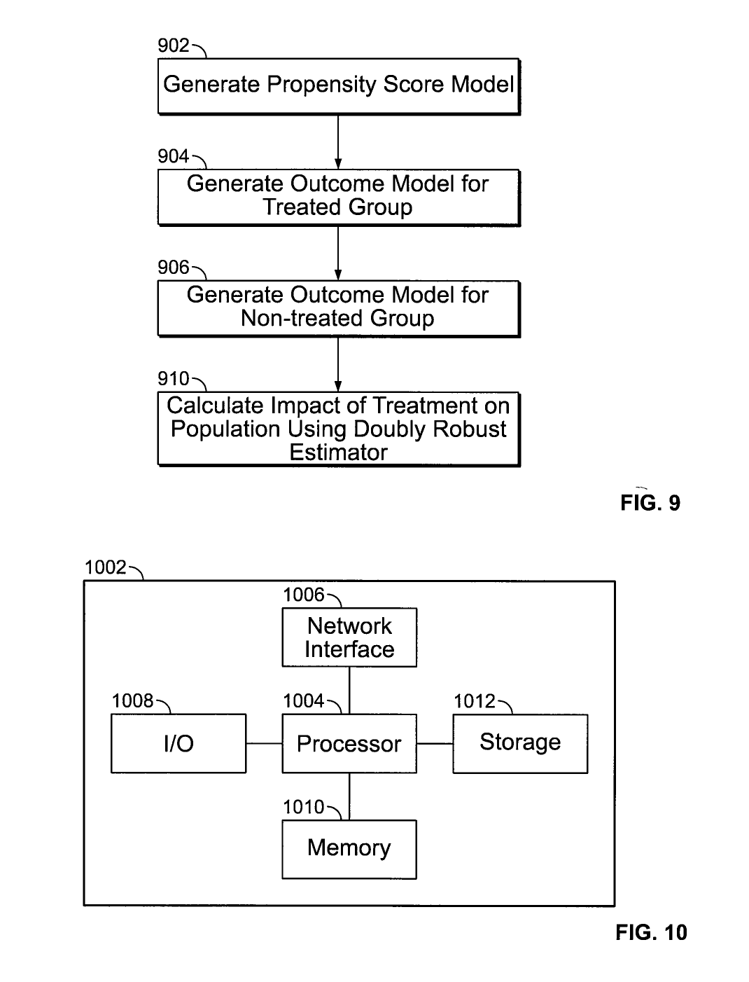

For scenario 2 and scenario 3, a DR estimator can be used to calculate the impact on the population. In the following discussion, let m₁(x)=E[Y¹|×=x] be the true outcome model for the treated group, and m₀(x)=E[Y⁰|X=x] bet the true outcome model for the non-treated group. FIG. 9 illustrates a method of calculating impact of a treatment in the population according to an embodiment of the present invention. The method of FIG. 9 can be used to implement step 508 of FIG. 5. Referring to FIG. 9, at step 902, a propensity score model is generated. The propensity model estimates a propensity score based on the feature values for each sample. The propensity score is an estimate of the likelihood of a particular sample of receiving treatment based on the feature values for that sample. In one embodiment, a propensity score model can be generated using SRF, as described above with reference to FIG. 8, for both scenario 2 and scenario 3. In another embodiment, for scenario 2, a logistic propensity score model can be generated, and for scenario 3, a propensity score model can be generated using SRF. A logistic propensity score is a propensity score model generated using logistic regression.

At step 904, an outcome model \hat{m}₁(x) is generated using the treated group. The outcome model \hat{m}₁(x) is an estimate of m₁(x) that can be used to predict the outcome for a set of feature values if subjected to the treatment. The outcome model \hat{m}₁(x) can be generated using a Random Forest algorithm with the treated group as training data.

At step 906, an outcome model \hat{m}₀(x) is generated using the non-treated group. The outcome model \hat{m}₀(x) is an estimate of m₀(x) that can be used to predict the outcome for a set of feature values if not subjected to the treatment. The outcome model \hat{m}₀(x) can be generated using a Random Forest algorithm with the non-treated group as training data.

At step 908, the impact of the treatment in the population is calculated using a doubly robust (DR) estimator. In particular, the impact in the population is calculated based on the estimated outcome models \hat{m}₀(x) and \hat{m}₁(x) and the estimated propensity model \hat{p}(x) using the DR estimator expressed in Equation (11) above, where Zᵢ is the status of a sample i (i.e., treated (1) or non-treated (0)), n is the total number of samples in the treated and non-treated groups, Y is the outcome for sample i, and xᵢ is the feature vector for sample i. It can be noted that if there is little overlap between propensity scores from the treated and non-treated groups, any estimation that is using the controls to estimate the counterfactuals for the treated or using the treated to estimate the counterfactuals for the non-treated may be suspect.

The above-described methods for analyzing impact of a treatment may be implemented on a computer using well-known computer processors, memory units, storage devices, computer software, and other components. Further, the above described impact analysis server and impact analysis tool can also be implemented on a computer using well-known computer processors, memory units, storage devices, computer software, and other components. A high level block diagram of such a computer is illustrated in FIG. 10. Computer 1002 contains a processor 1004 which controls the overall operation of the computer 1002 by executing computer program instructions which define such operations. The computer program instructions may be stored in a storage device 1012, or other computer readable medium (e.g., magnetic disk, CD ROM, etc.) and loaded into memory 1010 when execution of the computer program instructions is desired. Thus, the operations of the methods of FIGS. 5, 6, 7, 8, and 9 may be defined by the computer program instructions stored in the memory 1010 and/or storage 1012 and controlled by the processor 1004 executing the computer program instructions. The computer 1002 also includes one or more network interfaces 1006 for communicating with other devices via a network. The computer 1002 also includes other input/output devices 908 that enable user interaction with the computer 1002 (e.g., display, keyboard, mouse, speakers, buttons, etc.). One skilled in the art will recognize that an implementation of an actual computer could contain other components as well, and that FIG. 10 is a high level representation of some of the components of such a computer for illustrative purposes.

The foregoing Detailed Description is to be understood as being in every respect illustrative and exemplary, but not restrictive, and the scope of the invention disclosed herein is not to be determined from the Detailed Description, but rather from the claims as interpreted according to the full breadth permitted by the patent laws. It is to be understood that the embodiments shown and described herein are only illustrative of the principles of the present invention and that various modifications may be implemented by those skilled in the art without departing from the scope and spirit of the invention. Those skilled in the art could implement various other feature combinations without departing from the scope and spirit of the invention.

1. A method for analyzing an impact of a treatment of interest a population of on-line advertisers, comprising:
receiving data related to a treatment of interest and the population including a treated group of on-line advertisers and a non-treated group of on-line advertisers;
estimating propensity scores for the treated group and the non-treated group based on the data;
matching subgroups of the treated group and the non-treated group based on the propensity scores;
generating an outcome model for each subgroup of the non-treated group; and
calculating an impact of the treatment of interest on the treated group based on estimated outcomes for each subgroup of the treated group using the outcome model generated for the matching subgroup of the control group.

2. The method of claim 1, further comprising:
classifying the treatment of interest into one of a plurality of predetermined scenarios.

3. The method of claim 2, wherein the step of estimating propensity scores for the treated group and the non-treated group comprises:
estimating the propensity scores using an algorithm selected based on the classification of the scenario of the treatment of interest.

4. The method of claim 3, wherein the step of classifying the treatment of interest into one of a plurality of predetermined scenarios comprises:
determining whether there is a selection bias for selection of a contacted group of on-line advertisers out of the population;
if there is not a selection bias for the selection of the contacted group, determining whether there is a selection bias for selection of the treated group out of the contacted group;
if there is a selection bias for the selection of the treated group out of the contacted group, classifying the treatment of interest into a first scenario;
if there is a selection bias for the selection of the contacted group, determining whether the contacted group is the same as the treated group;
if the contacted group is the same as the treated group, classifying the treatment of interest into a second scenario; and
if the contacted group is not the same as the treated group, classifying the treatment of interest into a third scenario.

5. The method of claim 4, wherein the step of estimating the propensity scores using an algorithm selected based on the classification of the scenario of the treatment of interest comprises:
generating a propensity score model using a Random Forests algorithm when the treatment of interest is classified into the first scenario; and
generating a propensity score model using subsampled Random Forests when the treatment of interest is classified into one of the second scenario and the third scenario.

6. The method of claim 1, wherein the step of estimating propensity scores for the treated group and the non-treated group comprises:
generating a propensity model based on the data using a Random Forests algorithm.

7. The method of claim 1, wherein the step of estimating propensity scores for the treated group and the non-treated group comprises:
generating a propensity model based on the data using subsampled Random Forests.

8. The method of claim 1, wherein the step of generating an outcome model for each subgroup of the non-treated group comprises:
generating an outcome model for each subgroup of the non-treated group using Random Forests with the data corresponding to each respective subgroup of the non-treated group as training data.

9. The method of claim 1, wherein the step of calculating an impact of the treatment of interest on the treated group based on estimated outcomes for each subgroup of the treated group using the outcome model generated for the matching subgroup of the control group comprises:
estimating an expected outcome without treatment for each member of each subgroup of the treated group using the outcome model generated for the matching subgroup of the control group; and
comparing actual outcomes of the members of the treated group with the expected outcomes without treatment estimated for the members of the treated group.

10. The method of claim 9, wherein the step of comparing actual outcomes of the members of the treated group with the estimated expected outcomes without treatment for the members of the treated group comprises:
calculating a difference between a mean of the outcomes of the members of the treated group and a mean of the estimated expected outcomes without treatment for the members of the treated group.

11. The method of claim 1, further comprising:
generating an outcome model for the treated group;
generating an outcome model for the non-treated group; and
calculating an impact of the treatment of interest on the population based on the propensity scores and the outcome models for the treated group and the non-treated group.

12. The method of claim 11, wherein the step of calculating an impact of the treatment of interest on the population comprises:
calculating an impact measurement for the population based on the propensity scores and the outcome models for the treated group and the non-treated group using a doubly robust estimator.

13. An apparatus for analyzing an impact of a treatment of interest on a population of on-line advertisers, comprising:
means for receiving data related to a treatment of interest and the population including a treated group of on-line advertisers and a non-treated group of on-line advertisers;
means for estimating propensity scores for the treated group and the non-treated group based on the data;
means for matching subgroups of the treated group and the non-treated group based on the propensity scores;
means for generating an outcome model for each subgroup of the non-treated group; and
means for calculating an impact of the treatment on the population based on the propensity scores and the outcome models for the test group and the control group.

14. The apparatus of claim 13, further comprising:
means for classifying the treatment of interest into one of a plurality of predetermined scenarios.

15. The apparatus of claim 13, wherein the means for estimating propensity scores for the treated group and the non-treated group comprises:
means for estimating the propensity scores using an algorithm selected based on the classification of the scenario of the treatment of interest.

16. The apparatus of claim 13, wherein the means for estimating propensity scores for the treated group and the non-treated group comprises:
means for generating a propensity model based on the data using a Random Forests algorithm.

17. The apparatus of claim 13, wherein the means for estimating propensity scores for the treated group and the non-treated group comprises:
means for generating a propensity model based on the data using subsampled Random Forests.

18. The apparatus of claim 13, wherein the means for generating an outcome model for each subgroup of the non-treated group comprises:
means for generating an outcome model for each subgroup of the non-treated group using Random Forests with the data corresponding to each respective subgroup of the non-treated group as training data.

19. The apparatus of claim 13, wherein the means for calculating an impact of the treatment on the population based on the propensity scores and the outcome models for the test group and the control group comprises:
means for estimating an expected outcome without treatment for each member of each subgroup of the treated group using the outcome model generated for the matching subgroup of the control group; and
means for comparing actual outcomes of the members of the treated group with the expected outcomes without treatment estimated for the members of the treated group.

20. The apparatus of claim 19, wherein the means for comparing actual outcomes of the members of the treated group with the estimated expected outcomes without treatment for the members of the treated group comprises:
means for calculating a difference between a mean of the outcomes of the members of the treated group and a mean of the estimated expected outcomes without treatment for the members of the treated group.

21. The apparatus of claim 13, further comprising:
means for generating an outcome model for the treated group;
means for generating an outcome model for the non-treated group; and
means for calculating an impact of the treatment of interest on the population based on the propensity scores and the outcome models for the treated group and the non-treated group.

22. The apparatus of claim 11, wherein the means for calculating an impact of the treatment of interest on the population comprises:
means for calculating an impact measurement for the population based on the propensity scores and the outcome models for the treated group and the non-treated group using a doubly robust estimator.

23. A non-transitory computer readable medium encoded with computer program instructions for analyzing an impact of a treatment of interest of a population of on-line advertisers, the computer program instructions defining steps comprising:
receiving data related to a treatment of interest and the population including a treated group of on-line advertisers and a non-treated group of on-line advertisers;
estimating propensity scores for the treated group and the non-treated group based on the data;
matching subgroups of the treated group and the non-treated group based on the propensity scores;
generating an outcome model for each subgroup of the non-treated group; and
calculating an impact of the treatment on the population based on the propensity scores and the outcome models for the test group and the control group.

24. The non-transitory computer readable medium of claim 23, further comprising computer program instructions defining the step of:
classifying the treatment of interest into one of a plurality of predetermined scenarios.

25. The non-transitory computer readable medium of claim 24, wherein the computer program instructions defining the step of estimating propensity scores for the treated group and the non-treated group comprise computer program instructions defining the step of:
estimating the propensity scores using an algorithm selected based on the classification of the scenario of the treatment of interest.

26. The non-transitory computer readable medium of claim 23, wherein the computer program instructions defining the step of estimating propensity scores for the treated group and the non-treated group comprise computer program instructions defining the step of:
generating a propensity model based on the data using a Random Forests algorithm.

27. The non-transitory computer readable medium of claim 23, wherein the computer program instructions defining the step of estimating propensity scores for the treated group and the non-treated group comprise computer program instructions defining the step of:
generating a propensity model based on the data using subsampled Random Forests.

28. The non-transitory computer readable medium of claim 23, wherein the computer program instructions defining the step of generating an outcome model for each subgroup of the non-treated group comprise computer program instructions defining the step of:
generating an outcome model for each subgroup of the non-treated group using Random Forests with the data corresponding to each respective subgroup of the non-treated group as training data.

29. The non-transitory computer readable medium of claim 23, wherein the computer program instructions defining the step of calculating an impact of the treatment on the population based on the propensity scores and the outcome models for the test group and the control group comprise computer program instructions defining the steps of:
estimating an expected outcome without treatment for each member of each subgroup of the treated group using the outcome model generated for the matching subgroup of the control group; and
comparing actual outcomes of the members of the treated group with the expected outcomes without treatment estimated for the members of the treated group.

30. The non-transitory computer readable medium of claim 29, wherein the computer program instructions defining the step of comparing actual outcomes of the members of the treated group with the estimated expected outcomes without treatment for the members of the treated group comprise computer program instructions defining the step of:
calculating a difference between a mean of the outcomes of the members of the treated group and a mean of the estimated expected outcomes without treatment for the members of the treated group.

31. The non-transitory computer readable medium of claim 1, further comprising computer program instructions defining the steps of:
generating an outcome model for the treated group;
generating an outcome model for the non-treated group; and
calculating an impact of the treatment of interest on the population based on the propensity scores and the outcome models for the treated group and the non-treated group.

32. The non-transitory computer readable medium of claim 31, wherein the computer program instructions defining the step of calculating an impact of the treatment of interest on the population comprise computer program instructions defining the step of:
calculating an impact measurement for the population based on the propensity scores and the outcome models for the treated group and the non-treated group using a doubly robust estimator.
